(19) United States
(12) Patent Application Publication
(10) Pub. No.: US 2021/0121772 A1
(43) Pub. Date: Apr. 29, 2021

(54) SCRATCH-OFF LOTTERY TICKET CARD WITH MULTIPLE GAME TICKETS

(71) Applicant: Scientific Games International, Inc., Newark, DE (US)

(72) Inventor: Eugene Mark Audi, Atlanta, GA (US)

(21) Appl. No.: 16/665,257

(22) Filed: Oct. 28, 2019

(51) Int. Cl. A63F 3/06

(52) U.S. Cl. CPC A63F 3/0665

(57) ABSTRACT

A lottery ticket card includes a common game header section and a plurality of individual game tickets connected to and separable from the game header section. Each game ticket includes a separate and independently playable scratch-off lottery ticket and the common game header section comprises game identification information and instructions for play of the individual game tickets. A card code printed on the lottery ticket card uniquely identifies the lottery ticket card in a database, and a game ticket code printed on each individual game ticket uniquely identifies each of the individual game tickets in the database. Redemption of winning individual game tickets separated from the common header section is accomplished by entry of the game ticket code for the winning individual game ticket in the database.

### FIELD OF THE INVENTION

The subject matter of the present patent application relates generally to scratch-off lottery game tickets, and more particularly to a configuration of a lottery game card having multiple independent and separable game tickets.

### BACKGROUND

Lottery games have become a time honored method of raising revenue for state and federal governments the world over. Traditional scratch-off and on-line games have evolved over decades, supplying increasing revenue year after year. However, after decades of growth, it is recognized by both lotteries and lottery service providers that new and attractive game concepts must be introduced to the scratch-off lottery ticket industry to maintain the current player base and entice new players to sustain reasonable sales.

In this regard, the industry is exploring means for offering multiple games embodied in a single scratch-off lottery ticket as a way to generate excitement and increased enthusiasm with the tickets. For example, U.S. Pat. No. 8,512,123 proposes a method for implementing a ticket-based, multi-component lottery game wherein the lottery tickets include a first game component with a first prize structure and one or more additional game component(s) with a separate second prize structure. A first validation code is provided on the lottery ticket that is linked to a first game redemption algorithm in a server for validating and redeeming the first game component of the lottery ticket. One or more additional validation code(s) provided on the lottery ticket are linked to one or more separate redemption algorithms for validating and redeeming the additional game component(s) of the lottery ticket. Validation and redemption of the lottery ticket for the first and additional game components is enabled with separate redemption acts that do not necessarily include cross-communication between the first and additional game redemption algorithms.

With the multi-game tickets in the U.S. '123 patent, even though the games are separately playable, if either game on the ticket is a winning game, the player must retain the entire ticket in their possession, which may be undesirable for certain players.

The industry would benefit from a new multi-game scratch-off lottery ticket that appeals to players who find it burdensome to retain a relatively large ticket when only a small portion of the ticket is actually of any value in the event of a winning ticket play.

### SUMMARY

Objects and advantages of the invention will be set forth in the following description, or may be obvious from the description, or may be learned through practice of the invention.

In accordance with aspects of the invention, a lottery ticket card is provided that includes a common game header section on a front face thereof. A plurality of individual game tickets are connected to and separable from the common game header section, wherein each game ticket is a separate and independently playable scratch-off lottery ticket. The common game header section includes game identification information and instructions for play of the individual game tickets. A card code is printed on the lottery ticket card that uniquely identifies the lottery ticket card in a database, and a respective game ticket code is printed on each of the individual game tickets that uniquely identifies each of the individual game tickets in the database. The individual game tickets are separable from the common game header section such that redemption of winning ones of the individual game tickets separated from the common header section is accomplished by entry of the game ticket code for the winning individual game ticket in the database.

In a particular embodiment, the plurality of individual game tickets are separable from the common game header section by one or more perforation lines. The perforation lines may or may not run through the common game header section.

The card code may be provided in the common game header section, or in any other common area of the ticket card.

In certain embodiments, the ticket card may include a common game rules section provided on a back face of the lottery ticket card, the common game rules section including any manner of rules, instructions, or requirements related to play of the individual game tickets. With this embodiment, the card code may be provided in one or both of the common game rules section and the common header section.

In an alternate embodiment, an individual game rules section may be provided on a back face of each of the individual game tickets, wherein the card code may be provided in the common header section.

Aspects of the present invention also include a lottery ticket card game system that includes a plurality of the lottery ticket cards discussed above for distribution to players, wherein each card includes a plurality of individual game tickets connected to and separable from the common game header section. The system includes a central host computer configured with or in communication with a first database and a second database. A first electronic file is established in the first database for each of the lottery ticket cards, the first electronic file associated with the card code assigned to the lottery ticket card. A second electronic file is established in the second database for each of the individual game tickets, the second electronic files associated with the game ticket code assigned to the individual game ticket. With this system, redemption of winning ones of the individual game tickets separated from the common header section is accomplished by entry of the game ticket code for the winning individual game ticket in the second database.

In a certain embodiment of the system, for a given lottery ticket card, the second electronic files for the individual game tickets are linked to the first electronic file associated with the card code for the lottery ticket card in the central host computer, wherein redemption of winning ones of the individual game tickets remaining attached to the common header section is accomplished by entry of the card code in the first database or entry of the game ticket code for the winning individual game ticket in the second database.

Various embodiments of the system may incorporate any one or combination of the lottery ticket card features discussed above.

### BRIEF DESCRIPTION OF THE DRAWINGS

FIG. 1 is a front view of a lottery ticket card in accordance with an embodiment of the invention wherein the card incorporates two separate game tickets separable from a common header section;

FIG. 2 is a front view of the lottery ticket card of FIG. 1 after removal of the scratch-off coating from the individual game tickets;

FIG. 3 is a back view of the lottery ticket card of FIG. 1 depicting a common game rules section;

FIG. 4 is a back view of the lottery ticket card of FIG. 1 depicting an individual game rules section for each game ticket;

FIG. 5 is a front view of an embodiment of a lottery ticket card with a perforation pattern that separates the common game header section from the individual game tickets;

FIG. 6 is a front view of an alternate embodiment of a lottery ticket card with a perforation pattern that separates the common game header section from the individual game tickets;

FIG. 7 is a front view of still another embodiment of a lottery ticket card with a perforation pattern that separates the common game header section from the individual game tickets;

FIG. 8 is a front view of another embodiment of a lottery ticket card with a perforation pattern that separates the common game header section from the individual game tickets;

FIG. 9 is a diagram view of an embodiment of a lottery ticket game card system in accordance with aspects of the invention; and

FIG. 10 is a diagram view of an alternate embodiment of a lottery ticket game card system in accordance with aspects of the invention.

### DETAILED DESCRIPTION

Reference will now be made to various embodiments of the invention, one or more examples of which are illustrated in the drawings. It should be appreciated the embodiments are presented by way of explanation of the invention, and are not to be taken as a limitation of the invention. For example, features illustrated or described as part of one embodiment may be used with another embodiment to yield still a further embodiment. It is intended that the present invention encompass these and other modifications and variations as come within the scope and spirit of the invention.

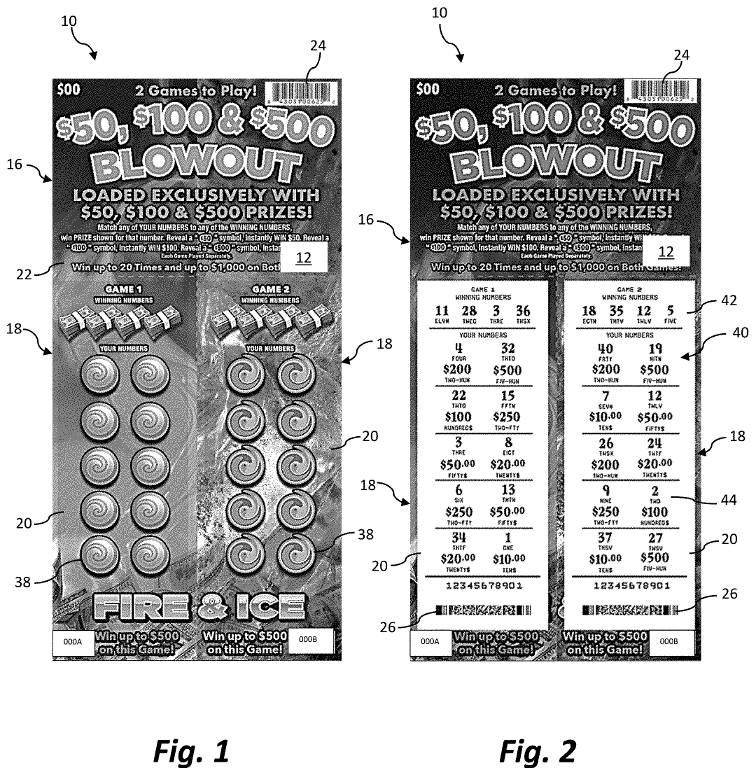

Referring to FIGS. 1 and 2, an embodiment of a lottery ticket card 10 in accordance with aspects of the invention is depicted. The card 10 may be made from any conventional stock or material commonly used in the production of conventional scratch-off lottery tickets. The card 10 includes a common game header section 16 printed on a front face 12 thereof. This header section 16 is an area of the card 10 that provides any manner of game information, such as instructions, graphics, game identification, etc., that is common to play of individual game tickets 18 that border at least one side of the common game header section 16, as discussed in greater detail below.

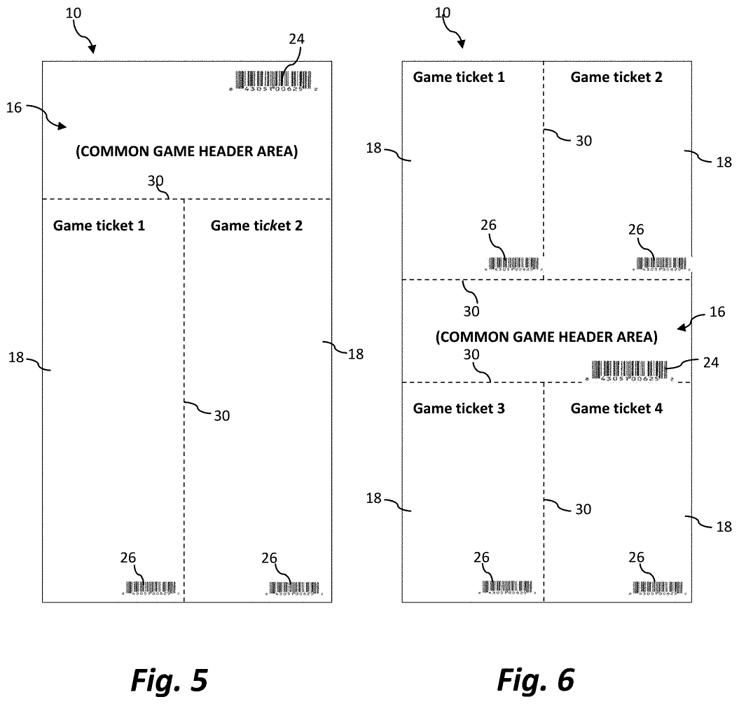

The card 10 includes a plurality of individual game tickets 18 that are each connected to and separable from the common game header section 16. For example, the individual game tickets 18 may be defined by any pattern of weakened lines, such as perforation lines 30 (FIGS. 5-8), that allow a player to easily and manually separate the game tickets 18 from each other and the common game header section 16. In the depicted embodiment, each of the individual game tickets 18 is an independently playable scratch-off lottery ticket 20. Such tickets 20 may be configured in any manner of conventional scratch-off games. For example, each ticket 20 may include certain “winning” indicia 42 and other “player” indicia 40, wherein matches between the winning indicia 42 and the player indicia 40 determine whether the ticket 20 is a winning ticket and the prize award. The indicia 40, 42 is covered by a scratch-off coating (SOC) 38 that is removed by the player (as depicted in FIG. 2) for play of the ticket 20, as is well-known. It should be readily appreciated that the card 10 is not limited by the type, configuration, or play of the individual game tickets 18, or embodiments of the game tickets 18 in the form of scratch-off lottery tickets 20.

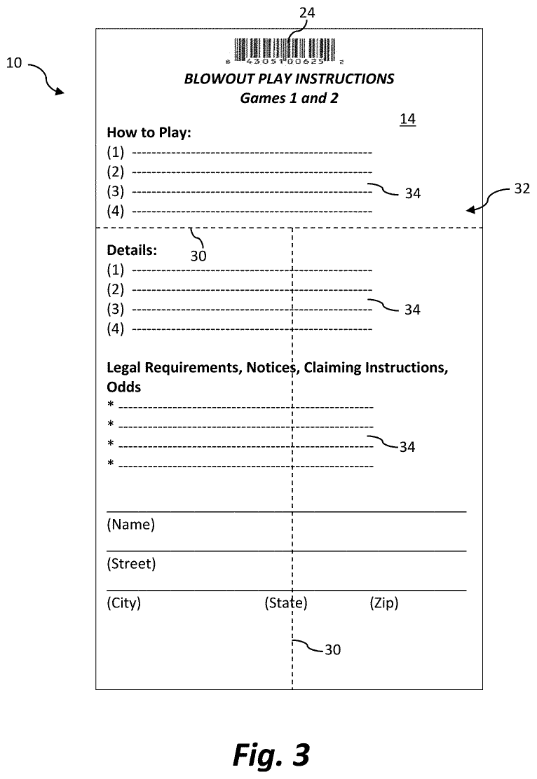

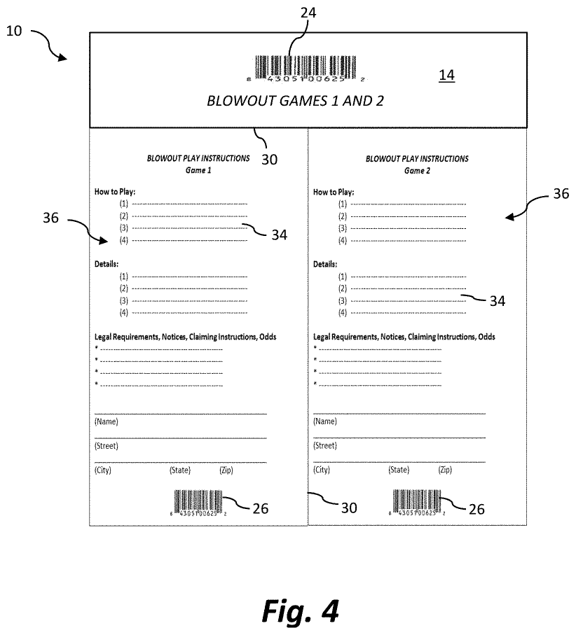

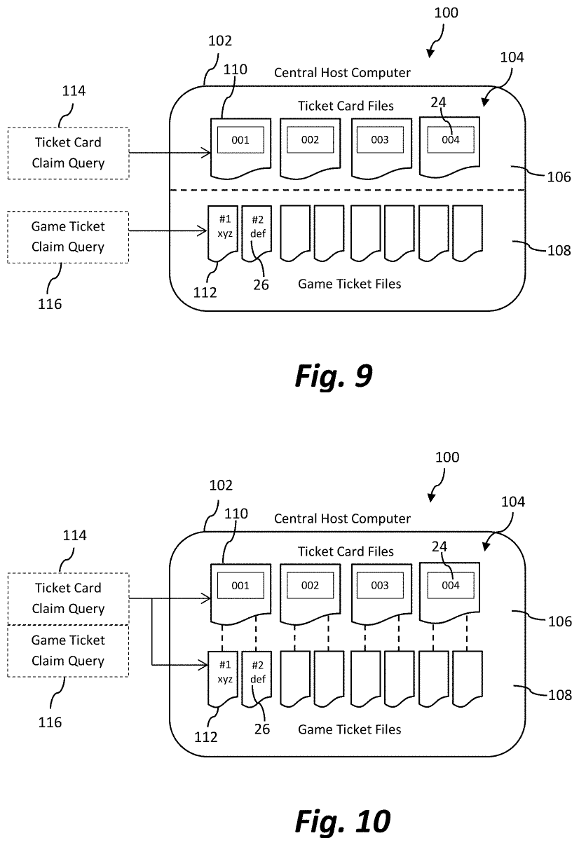

Still referring to FIGS. 1 and 2, each card 10 includes a card code 24 (e.g., a bar code, alpha-numeric code, Q-code, or the like) printed thereon that uniquely identifies the lottery ticket card 10 in a database 104 (FIGS. 9 and 10), as explained in greater detail below. The card code 24 is preferably printed in the common game header section 16 of the card 10 (front face 12 as in FIG. 1 or back face 14 as in FIGS. 3 and 4), and may also be provided on each individual game ticket 18.

Each of the individual game tickets 18 has a respective game ticket code 26 is printed thereon (front or back of the game ticket 18). In the embodiment of FIGS. 1 and 2, this code 26 is printed under the SOC on each of the individual game tickets 18. The code 26 may also (or alternatively) be printed on the back of each individual game ticket 18, as depicted in FIGS. 4-6. The game ticket code 26 (e.g., a bar code, alpha-numeric code, Q-code, or the like) uniquely identifies each of the individual game tickets 18 in the database 104.

The individual game tickets 18 are separable from the common game header section 16 such that the player need only retain winning ones of the game tickets 18. For example, if the card 10 has four individual game tickets 18, and only one such game ticket 18 is a winning ticket, the player can separate the winning game ticket 18 and discard the common header section 16 and other game tickets 18. The winning game ticket 18 can be redeemed by the player presenting the game ticket 18 at a redemption location, wherein the game ticket code 26 can be scanned and used to locate a file in the database 104 that contains the validation/redemption information for the game ticket 18.

As mentioned, the plurality of individual game tickets 18 may be separable from the common game header section 16 and each other by one or more perforation lines 30. Various patterns of perforation lines 30 and individual game tickets 18 are shown in FIGS. 5 through 8. For example, in FIG. 5, the ticket card 10 has a common game header section 16 at the top of the card 10 with two side-by-side game tickets 18 in the reaming portion of the card 10. A single horizontal perforation line 30 separates the game tickets 18 from the common header section 16, and a single perforation line separates the game tickets 18 from each other. Thus, in this embodiment, the perforation lines 30 do not run through the common game header section 16.

In the embodiment of FIG. 6, the common game header section 16 is centrally located on the card 10 and bordered on both sides by two game tickets 18 (total of four game tickets 18). The common game header section is thus separated by two perforation lines (top and bottom) and the game tickets 18 are separated from each other by a perforation line 30.

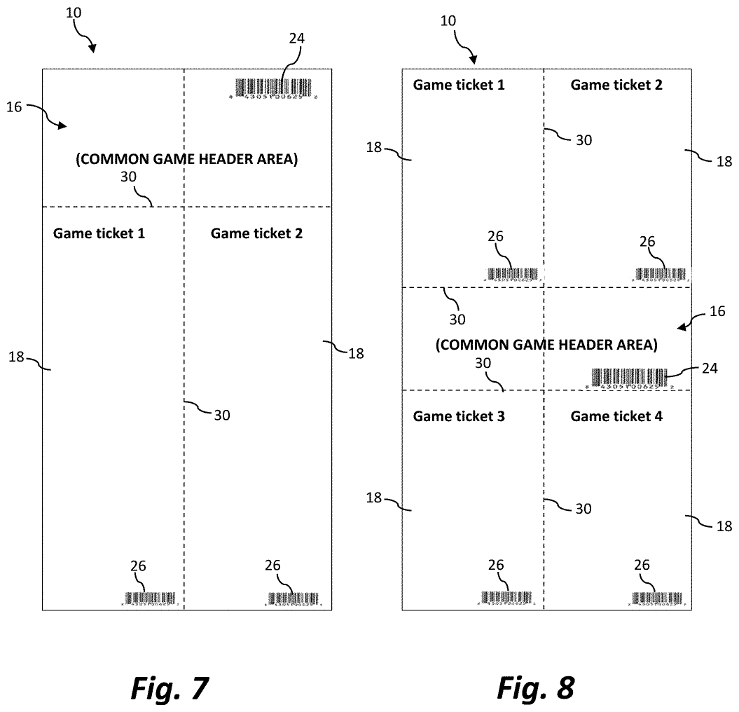

The embodiment of FIG. 7 is similar to that of FIG. 5 with the exception that the perforation line 30 that separates the game tickets 18 runs the length of the card 10 and thus extends through the common game header section 16.

Likewise, the embodiment of FIG. 8 is similar to that of FIG. 6 with the exception that a single perforation line 30 separates the game tickets 18 from each other and runs the length of the card 10 through the common game header section 16.

Referring to FIGS. 3 and 4, the ticket card 10 may include a common game rules section 32 provided on the back face 14 of the lottery ticket card 10, wherein the common game rules section 32 includes any manner of indicia 34 related to rules, instructions, or legal notices and requirements related to play of the individual game tickets 18. With this embodiment, the card code 26 may also (or alternatively) be provided in the common game rules section 32, as depicted in FIG. 3.

In the embodiment of FIG. 3, the common game rules section 32 includes the back of the common header section as well as the remaining back face 14 of the ticket card 10. The indicia 34 is thus printed partially onto the back of each of the individual game tickets 18.

Certain jurisdictions, however, may require that the game rules/requirements indicia 34, particularly the legal notices and requirements, be provided on each individual game ticket 18. Thus, in the embodiment of FIG. 4, an individual game rules section 36 is provided on the back of each individual game ticket 18.

Referring to FIGS. 9 and 10, aspects of the present invention also include a lottery ticket card game system 100 that includes a plurality of the lottery ticket cards 10 discussed above for distribution to players. The ticket cards 10 may be configured with any one or combination of the features discussed above. The system 100 includes a central host computer 102 that may be maintained by a lottery service provider, a lottery jurisdiction or governmental body, or combination of both. The configuration and infrastructure of a lottery system with a central host computer 102 for performing various accounting, validation, redemption, and other responsibilities across a wide lottery jurisdiction is well-known and need not be described in detail herein.

The central host computer 102 is configured with or in communication with database 104, which may include multiple sub-databases. For example, in the embodiment of FIG. 9, the database 104 includes a first database 106 and a second database 108. In this particular embodiment, the first database 106 may include a first electronic file 110 for each of the lottery ticket cards 10, wherein the first electronic file 110 is associated with the card code 24 assigned to the respective lottery ticket card 10. This first electronic file 110 may include validation information for each of the individual game tickets 18 configured with the card 10 (all game tickets 18 or just winning game tickets 18). Thus, with this embodiment, a player holding a ticket card 10 having one or more winning game tickets 18 may simply present the ticket card 10 in its entirety for redemption. The card code 24 may be entered into the first database 106 as a “ticket card claim query” 114 for validation of any individual game ticket 18. Thus, with this embodiment, it is possible for a player to simply present a ticket card 10 (with card code 24) for redemption without ever playing the individual game tickets 18.

The lottery provider may establish redemption rules whereby if a ticket card 10 is presented for redemption by a player and the first electronic file 110 associated with the respective ticket card code 24 indicates that the card 10 contains a winning game ticket 18, then such winning game ticket 18 must be attached or presented with the common game header section 16. This may deter attempts at multiple redemption by an unscrupulous player presenting the individual game ticket 18 for redemption and then at a later time presenting just the game header section 16 (with card code 24) claiming that he/she has “lost” the winning game ticket 18. In other words, in certain embodiments, to redeem a winning game ticket 18, such game ticket 18 must be presented for redemption, either individually or attached to the common header section 16.

Still referring to FIG. 9, a second database 108 associated with the overall database 104 (and central host computer 102) may include a second electronic file for at least each of the winning individual game tickets 18 (or all of the game tickets 18 of a ticket card 10). The second database 108 can be used when a player simply presents an individual winning game ticket 18 for redemption, wherein the game ticket code 26 can be entered via a game ticket claim query 116 directly to the second database 108 to retrieve the validation information for the respective winning game ticket 18.

FIG. 10 depicts an embodiment of the system 100 wherein the first electronic files 110 in the first database 106 are linked with the respective second electronic files 112 in the second database 108. With this configuration, it is not necessary for the first electronic files 110 to contain the validation information for each of the game tickets 18 associated with a card code 24. If a redemption claim is made via a query 114 with the card code 24, then the individual second electronic files 112 can be accessed directly through the link with the first electronic file 110. If a redemption claim is made via a query 116 with the game ticket code 26 from an individual winning game ticket 18, then the first electronic files 110 are bypassed and the second electronic files 112 are accessed directly.

It should be appreciated that the term “host computer” or “host “server” is used herein to encompass any configuration of computer hardware and software that is maintained by a lottery authority or game provider to carry out the functionalities of the present system 100 and associated method, as well as any manner of additional lottery functions known to those skilled in the art. It should be readily appreciated that the host computer 102 may include an integrated server, or any manner of periphery server or other hardware structure. The central host computer 102 is typically remote from the authorized lottery retail establishments, and is in communication with the establishments via a suitable secure communication network, which may include any manner of wide area network, wireless internet, or cloud computing. The host computer 102 may be a single networked computer, or a series of interconnected computers having access to the communications network via a gateway or other known networking system. Generally, the host computer 102 is configured to communicate with, manage, execute and control individual lottery terminal units within the lottery jurisdiction. The host computer 102 may be a “front end” server provided by the lottery game provider that is interfaced with the existing draw/instant game system infrastructure one or more separate lottery authorities. The host computer 102 may include a memory for storing gaming procedures and routines, a microprocessor (MP) for executing the stored programs, a random access memory (RAM) and an input/output (I/O) bus. These devices may be multiplexed together via a common bus, or may each be directly connected via dedicated communications lines, depending on the needs of the system 100.

The central host computer 102 may be directly or indirectly connected through an I/O bus to any manner of peripheral devices such as storage devices, wireless adaptors, printers, and the like. In addition, the databases may be communicatively connected to the host computer 102 and provide a data repository for the storage and correlation of information discussed above related to the ticket cards 10 and individual game tickets 18.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

1. A lottery ticket card, comprising:
a common game header section on a front face of the lottery ticket card;
a plurality of individual game tickets connected to and separable from the common game header section, each game ticket comprising a separate and independently playable scratch-off lottery ticket, the common game header section comprises game identification information and instructions for play of the individual game tickets;
a card code printed on the lottery ticket card that uniquely links the lottery ticket card to a first electronic file in a database that contains validation information on all of the individual game tickets contained in the lottery ticket card;
a game ticket code printed on each of the individual game tickets that uniquely links each of the individual game tickets to a second electronic file that is separate from the first electronic file and contains validation information only for the individual game ticket associated with the game ticket code;
wherein redemption of winning individual game tickets separated from the common header section is accomplished by entry of the game ticket code for the winning individual game ticket in the database and redemption of winning ones of the individual game tickets remaining attached to the common header section is accomplished by entry of the card code or entry of the game ticket code for the winning individual game ticket.

2. The scratch-off lottery ticket card as in claim 1, wherein the plurality of individual game tickets are separable from the common game header section by one or more perforation lines.

3. The scratch-off lottery ticket card as in claim 2, wherein the perforation lines do not run through the common game header section.

4. The scratch-off lottery ticket card as in claim 2, wherein one or more of the perforation lines run through the common game header section.

5. The scratch-off lottery ticket card as in claim 1, wherein the card code is provided in the common game header section.

6. The scratch-off lottery ticket card as in claim 1, further comprising a common game rules section provided on a back face of the lottery ticket card, the common game rules section comprising rules and requirements related to play of the individual game tickets.

7. The scratch-off lottery ticket card as in claim 6, wherein the card code is provided in one or both of the common game rules section and the common header section.

8. The scratch-off lottery ticket card as in claim 1, further comprising an individual game rules section provided on a back surface of each of the individual game tickets, the card code provided in the common header section.

9. A lottery ticket card game system, comprising:
a plurality of lottery ticket cards for distribution to players;
each of the lottery ticket cards comprising:
a common game header section on a front face of the scratch-off lottery ticket card;
a plurality of individual game tickets connected to and separable from the common game header section, each game ticket comprising a separate and independently playable scratch-off lottery ticket, wherein the common game header section comprises game identification information and instructions for play of the individual game tickets;
a card code printed on the lottery ticket card that uniquely identifies the lottery ticket card;
a game ticket code printed on each of the individual game tickets that uniquely identifies each of the individual game tickets;
a central host computer configured with or in communication with a first database and a second database;
a first electronic file in the first database for each of the lottery ticket cards, the first electronic file linked with the card code assigned to the lottery ticket card and containing validation information on all of the individual game tickets;
a second electronic file in the second database for each of the individual game tickets, the second electronic files linked with the game ticket code assigned to the individual game ticket and containing validation information only for the individual game ticket associated with game ticket code; and
wherein redemption of winning individual game tickets separated from the common header section is accomplished by entry of the game ticket code for the winning individual game ticket in the second database and redemption of winning ones of the individual game tickets remaining attached to the common header section is accomplished by entry of the card code or entry of the game ticket code for the winning individual game ticket.

10. The scratch-off lottery ticket card game system as in claim 9, wherein for a given lottery ticket card, the second electronic files for the individual game tickets are linked to the first electronic file associated with the card code for the given lottery ticket card in the central host computer.

11. The scratch-off lottery ticket card game system as in claim 10, wherein the plurality of individual game tickets are separable from the common game header section by one or more perforation lines.

12. The scratch-off lottery ticket card game system as in claim 10, wherein the card code is provided in the common game header section.

13. The scratch-off lottery ticket card game system as in claim 10, further comprising a common game rules section provided on a back face of the scratch-off lottery ticket card, the common game rules section comprising rules and requirements related to play of the individual game tickets.

14. The scratch-off lottery ticket card game system as in claim 13, wherein the card code is provided in one or both of the common game rules section and the common header section.

15. The scratch-off lottery ticket card game system as in claim 10, further comprising an individual game rules section provided on a back face of each of the individual game tickets, the card code provided in the common header section.
